(19) United States
(12) Patent Application Publication
(10) Pub. No.: US 2016/0088063 A1
(43) Pub. Date: Mar. 24, 2016

(54) Interactive Social Platform

(71) Applicant: V PROUD LLC, NEW YORK, NY (US)

(72) Inventors: Karen Cahn, Montclair, NJ (US); Shilpa Raut, Lodi, NJ (US); Kristin Guinan, Arvada, CO (US)

(21) Appl. No.: 14/491,418

(22) Filed: Sep. 19, 2014

(51) Int. Cl. H04L 29/08; G06F 3/0481

(52) U.S. Cl. CPC H04L 67/10; G06F 3/0481; H04L 67/30

(57) ABSTRACT

A network based system comprising an interface accessible from the network via which a human client submits content for publication on a platform. Information related to the content is available on a database and an administrative interface associated with the database is configured to publish the content from the human client on the network based system.

### FIELD OF THE INVENTION

The present disclosure relates generally to network based systems for digital social media and user communications. More particularly, the disclosure relates to Internet based systems and/or websites on the world wide web which permit a user to participate on a social media platform, comment on content and submit content for consideration in an existing editorial environment.

### BACKGROUND

A variety of websites present social media platforms where users can comment on a news item or the like. Often, such platforms take the form of blogs. FACEBOOK is an example of a platform that includes a blog in addition to a host of other features for linking to other users. Some of the platforms are secured or for the exclusive use of registered users who must present login credentials to access the content and/or interact with the content by e.g. posting a comment.

### SUMMARY

The present disclosure provides one or more inventions that impact interactions of a user and a website. The interaction(s) is/are particularly applicable to social media websites and other similar platforms. In particular, aspects of the present disclosure solve problems in existing social media platforms.

For example, in an embodiment, there is a provided a platform where a user can have both a public login, where a person's public identity is known and all actions, such as commenting, conversations or submissions under the public login are attributed to the public identity and a private identity or alias where the same person can comment, converse or make submissions in anonymity. In a variation of this embodiment, both the public and private identity are attributed to the same individual and verified during the sign up process at the same time.

In another embodiment, content on the platform is presented in a format that is easy to decipher and search in order to permit users to connect with like-minded users, engage in commentary on topics of interest, start a subset of comments or submit content in an existing editorial environment.

In a more particular embodiment, the disclosure provides a network based system having an interface accessible from said network via which a human client submits content for publication on a platform, a database comprising information related to the content and an administrative interface associated with the database comprising a matrix for the content. In this embodiment the administrative interface is configured to publish the content from the human client on the network based system.

In an embodiment, there is provided an administrative interface configured to edit the content before publication on the platform.

In an embodiment, content is not published on the platform until the administrator approves the content for publication.

In an embodiment, there is provided a network based system having an interactive platform via which a human client can select a topic and view content related to the topic.

In an embodiment, there is provided an account to access the network based system. The account can be created within existing social network public identity accessed through an API to create a public account or an account designator and corresponding password can be selected to create a private account.

In an embodiment, there is provided that the public account and private account are associated with each other. Further, an embodiment provides a human client can switch between a public account and private account on the network based system.

In an embodiment there is provided an interactive questionnaire is associated with each topic and the human client provides a response to the questionnaire. Further, in an embodiment a plurality of human client responses are on the platform.

In an embodiment, there is provided that the plurality of human client responses are coded according each human client response. Further, the plurality of human client responses are color coded or compiled in an illustrative chart.

In an embodiment, there is provided a network based system having an interface accessible from said network via which a human client submits a comment on a platform and a means on the platform for flagging the comment by other users and an administrative interface associated with the platform comprising a matrix of flagged content. Further, each comment is associated with a human client, and the administrative interface is configured to review the comment.

In an embodiment, it is provided the administrative interface is configured to automatically delete any comment with a predetermined number of flags. Further, in an embodiment the administrative interface is configured to override the automatic deletion of a comment for a human client selected by the administrative interface.

Other systems, methods, features, and advantages of the present invention(s) will be or will become apparent to one with skill in the art upon examination of the following figures and detailed description. It is intended that all such additional systems, methods, features, and advantages be included within this description, be within the scope of the disclosure, and be protected by the accompanying claims.

### BRIEF DESCRIPTION OF THE DRAWINGS

The accompanying drawings, which are incorporated in and constitute a part of this specification, illustrate an implementation of the present disclosure and inventions embodied therein and, together with the description, serve to explain the advantages and principles of the invention. In the drawings:

FIG. 1 illustrates a system with which the invention(s) can be practiced.

FIG. 2A illustrates the web pages through which a client can wend in order to interact with the platform.

FIG. 2B illustrates the sign up process for a client.

FIG. 2C illustrates the login process for a client.

FIG. 3A illustrates an embodiment of a conversation(s) as described herein.

FIG. 3B illustrates an embodiment of a layout for a conversation(s) and the interactive interface

FIGS. 4A-4C illustrate the search function on the platform.

FIG. 5 illustrates how a client can submit content to the platform.

FIGS. 6A-6B illustrate an interface file useful in the system described herein.

FIG. 7 illustrates how a client can submit content to the platform.

FIGS. 8A-8B illustrate interface files useful in the system described herein.

FIG. 9 illustrates a system administration database matrix useful in the system described herein.

FIG. 10 illustrates a system administration database matrix useful in the system described herein.

FIG. 11 illustrates how comments on the system described herein can be monitored.

FIG. 12 illustrates an interface file useful in the system described herein.

### DETAILED DESCRIPTION

In a broad sense, the present disclosure provides a means for improving user interaction on a platform via a network, preferably the Internet.

Accompanying this application is an Appendix, fully incorporated herein by reference, which comprises a print out of files or web pages presented to a user navigating through the presently preferred platform. References are made herein to specific pages therein for ease of reference. Further, it is understood that words contained in quotes, e.g. “delete” or “join conversation” mean the action that can be taken from the words themselves.

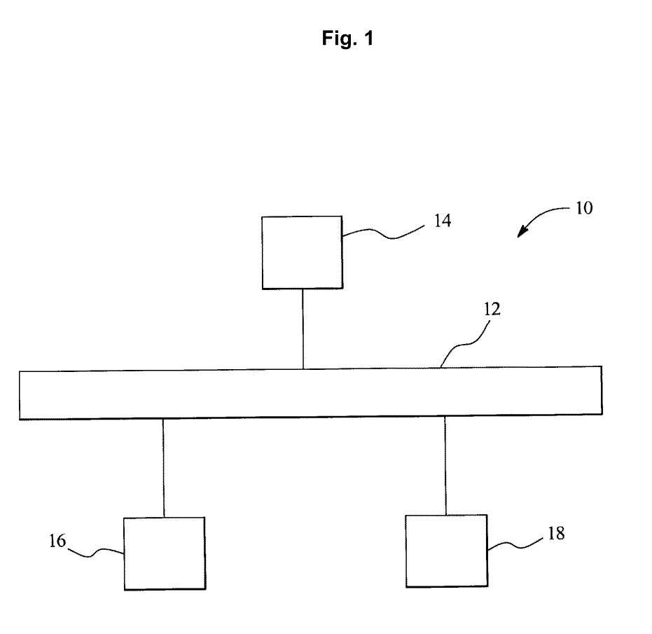

In FIG. 1 there is illustrated a system 10 with which the disclosure can be practiced. The system 10 comprises a network 12 such as the Internet or other suitable network, albeit public or private. Connected to the network 12 by suitable means is a server (or group of servers) 14 on which are stored files for a platform, some of which are to be accessed by a remote or client computer 16. The remote computer 16 is referred to herein also as a client computer or simply client, when appropriate. Further, a person or user accessing the files via the client computer can be referred to as a client (or more appropriately a user in the social media context). Distinctions herein, to the extent important, generally should be readily understood by a person of ordinary skill in the art. Finally, there is illustrated a remote administrator's computer 18 which also can access the files on the server.

The computers 16 and 18 can be connected to the network in a variety of ways, including using routers, e.g. via dial-up access, direct connection or wireless connection to name a few. Since the system herein is described in terms of a social media platform, it is envisioned that most of the connections of the remote computers to the network will be made through wireless access, such as that provided by an Internet access provider account.

In that regard, the network 12 then preferably comprises the Internet and the files on the server 14 which comprises hyper text mark-up language files (HTML) such as commonly accessed over the world wide web. Further, while only one server is illustrated in FIG. 1, the files could be distributed throughout various servers as would be understood by a person of ordinary skill in the art.

In the embodiment set forth in the figures, a system preferably is provided for the delivery of an interactive social media platform. In particular, a platform that allows a user to participate publicly with a known social user name, privately with a private identity (e.g. an alias), or both. In each instance the identity of the user is verified when the user creates an account and during the login process. More specifically, the user can elect to login under its public or private identity, or toggle between the identities once logged in or signed into the platform. A user's interactions, posts, comments and conversations will be available for others to view. However, the users interactions will be attributed to the identity under which they have logged in. For example, if a user is logged in under a public identity, comments, posts and other interactions will be seen by others and associated with the user's public identity. If a user is logged in under its private identity or alias, the user's comments, posts, and other interactions will be seen by others but associated with the user's private identity or alias, not their public identity or known social user name.

Further, the illustrated system facilitates the sorting and processing of information available on the platform in a way that allows users to decipher information easily, follow like-minded users, debate specific topics of interest and navigate other user posts, comments and conversation(s).

Additionally, the illustrated system also allows a user to submit content within the context of an existing editorial environment. As is typical for sites on the world wide web, in addition to textual information and/or other multimedia information, including video content, the pages include hyperlinks to other pages or sites or HTML files, which can also be considered interfaces. Unless otherwise noted herein, the terms web site, web page, page, platform and HTML file are used interchangeably herein. Thus, the client can be redirected to specific interfaces, depending upon the hyperlink chosen.

In addition to the homepage (see Appendix page 1), the following basic web pages or files are provided in the presently preferred embodiment:

(a) “sign up”

(b) “Login”

(c) “Conversation(s)”

(d) Category selection pages, “Categories” e.g. “News,” “Hotness,” “Health,” “Sex Life,” “Relationships,” “Parenting,” and “The Cray,”

(d) “Profile”

(e) “+New Conversation” or “Start a New Conversation”

(f) “Topics”

(g) “search”

(h) “Terms of Use”

(i) “Privacy Policy”

(j) “Site Map”

(k) Settings

(m) About Us

(n) Team Bios

(o) Code of Conduct

(p) FAQ/Help

(q) Contact Us

The homepage provides a file containing only the most basic information about the platform. This page is the page to which a client is linked or directed to when using the basic URL for the system.

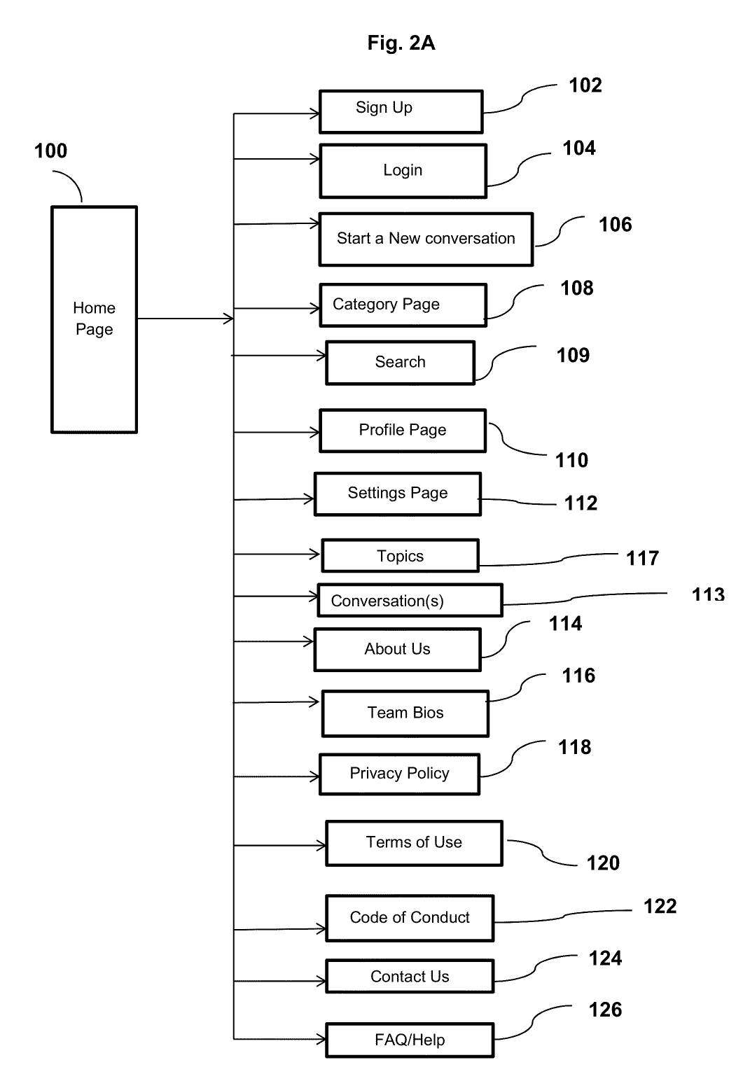

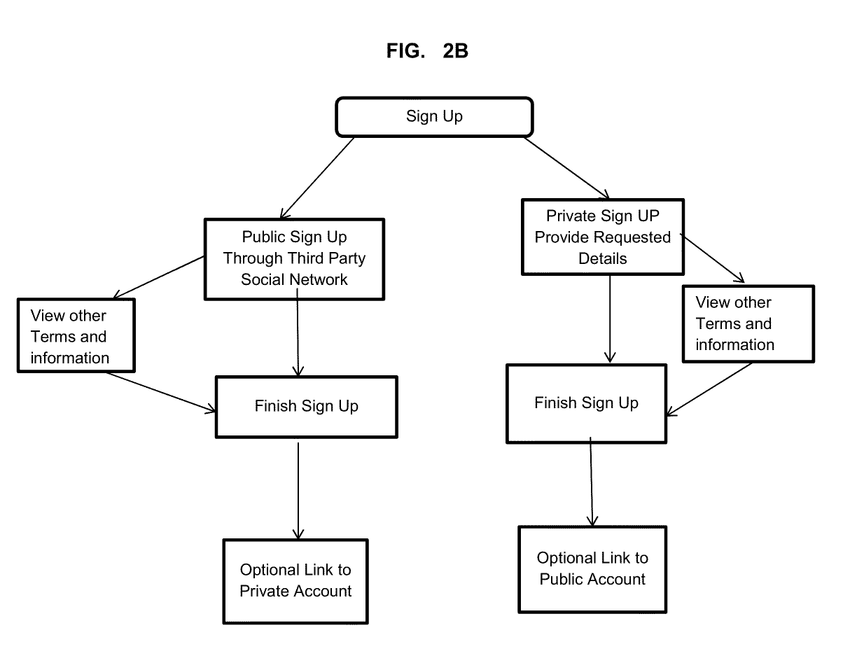

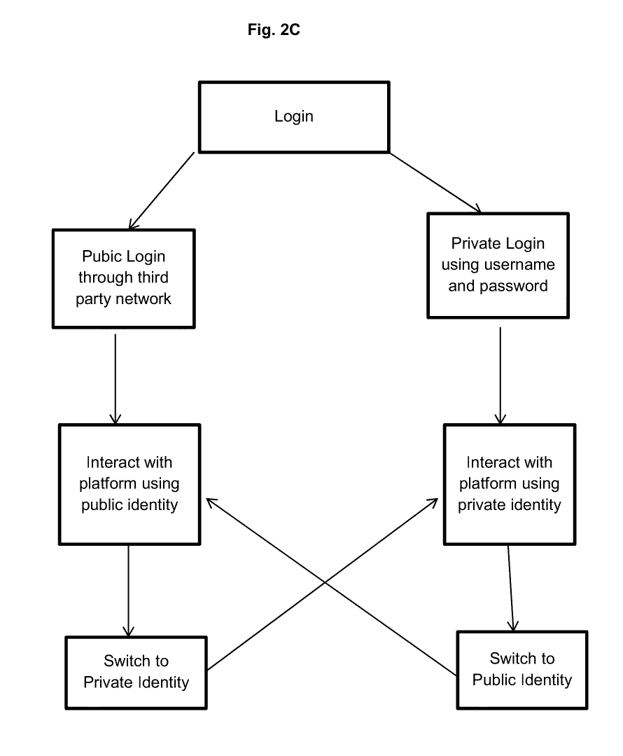

FIG. 2A provides a diagram illustrating an overview of the hyperlinking logic of the various pages or websites making up the presently preferred system embodiment of principles of the disclosure. As illustrated after a user accesses the homepage, they can continue to navigate or browse the platform by selecting an appropriate link. In the presently preferred embodiment, the home page includes basic textual and graphical interface and HTML links to various files/interfaces of the system. Via adjacent frames, a user can hyperlink to the following areas of the system: “topics,” “Categories,” “Search,” Conversation(s),” “sign-up,” “login” “new conversation,” “profile page,” “Sitemap,” “Disclaimers,” “Terms of Use,” or “Privacy Policy.” Some of these frames, such as “topics” can be in the form of a task bar arrangement where hyperlinks are provided to additional files/interfaces such as “News,” “Hotness,” “Health,” “Sex Life,” “Relationships,” “Parenting,” “The Cray.” The taskbar can also include a hyperlink to “+New Conversations,” which provides a user with the functionality of submitting content for possible publication on the platform. These file/interfaces can be changed to reflect new or different categories or topics of interest.

In the Appendix, shortened names are used for these files. Of course the home page, as well as any other page can be formed using frames so that the foregoing second frame's linking selection is presented in a menu adjacent each page discussed herein. As is well-known, “frames” is the use of multiple, independently controllable sections on a web presentation. This effect is achieved by building each section as a separate HTML file and having one “master” HTML file identify all the sections. When a user requests a web page that uses frames, the address requested is actually that of the “master” file that defines the frames. The result of the request is that multiple HTML files are returned, one for each visual sections. Links in one frame can request another file that will appear in another (or the same) frame. A typical use of frames is to have one frame containing a selection menu in on frame and another frame that contains the space where the selected files (i.e. the linked to files) appear. See, www.whatis.com for more information about this and other terms utilized in connection with the Internet and world wide web.

In the presently preferred embodiment, a lower frame, such as the second frame is presented to the user to enable the user to hyperlink to various sites mentioned above. These sites or files are described next.

The Files

“Sign Up”

This file allows a user to create a new account by completing the necessary fields. As part of the signup process, the user can create an account designator for a public identity typically accessed through a social network, and/or a private identity. A user can choose to create a public identity, a private identity, e.g. an alias or both. When a user creates a public identity they can use social network login credentials to access the platform via an API, for a private identity, a user must also select a username as an alias and a password that is associated with its private identity and the user account in order to access account information and login to the platform. During the account creation process, the public and/or private aliases selected by the user are both verified and linked on the server side to the public identity, however, the private identity is not linked to the public identity when viewed by other third parties. Accordingly, the private identity permits anonymous posting and platform interaction by a user. If a user elects to create an account via a third party social network, the user credentials from the third party social network can be used in creating the account.

“Login”

Once an account is created, the user can login to an existing account by selecting the “login feature.” When the user has linked to the login page or window, the user is prompted with the option to sign in with their public identity using a social network such as FACEBOOK, TWITTER, GOOGLE+ or LINKEDIN or sign in under a private identity by inputting an account designator and corresponding password. When a user logs-in under a third party social network or other public sign-on option, other users will be able to see all the users platform interactions and submissions are associated with the user's public identity or profile. In some embodiments, the other platform users may be able to see if a certain user is logged-in on the platform. Certain information provided under this identity may also be tracked by the social network sign-in identity a user selects. If the user logs in under their private identity, they can navigate and interact with the platform in the same manner as if they were logged in publicly, but in an anonymous fashion. These interactions will appear linked to the private alias selected by the user such as “IowaCityMama” on the client side and will also be linked to the user (and their public identity) on the server side. Once logged into the platform, the user can toggle between their identities to permit some interaction to be under its public identity and other interaction to be under its private identity.

“Conversation(s)”

This file contains lead in content and an associated with a headline and any user comments related to the lead in content and headline. The lead in content can be a video link an article, image, link or other content. This file can appear as a frame on the homepage, and contain additional frames that permit a user to “comment” or “join the conversation.” For example, the user can elect to express an opinion on a particular headline by providing a comment. By providing a comment a user “joins the conversation” about the headline.

Supporting content related to the lead in content and headline can also be accessible on the same page as the lead in content and headline. Supporting content can include by way of example, other articles, videos, votes, op-eds and images. The above described template can be used to create many lead in content pieces and associated headlines, e.g. conversations to be hosted on the platform and organized by various categories and subcategories.

In an embodiment of the disclosure, the headline can be a statement or question that prompts the user to respond by stating “yes,” “no” or “not sure” and provide comments based on their vote or selection. Each user that elects to vote on the headline and provide commentary results in a post on the web page. In order to make the comments more accessible and searchable the comments can be coded. For example, all comments that “agree” are coded green, all comments that “disagree” are coded red and all comments that are “not sure” are coded yellow. The comments are not limited to color coding, but can be sorted based on a number rating, i.e. a range from 1 to 5 where 1 is strongly disagrees and 5 is strongly agrees and other coding systems known to persons of ordinary skill in the art. Additionally, the comments can be sorted in a variety of ways including a graphical representation showing a breakdown of the results. For example, a pie chart or bar graph can demonstrate the breakdown in the consensus amongst the respondents. When implemented, the coding system allows users to decipher information easily and find other users with similar or differing views. Further, a sorting function that allows similarly coded comments to be grouped together or compared with each can be provided.

“Side Conversation”

This file allows a user to start a new comment stream that can consist of a subset of comments related to the original comment stream, view a new comment stream initiated by another user and in either case submit a comment. The new comment stream is linked to the original comment stream, or main comment, but the comments posted under the new stream are separate from the original thread. For example, a user can choose to directly comment on another user's comment and by doing so establish a new comment stream. The new comment thread or “side conversation” can be viewed by other users or commented on by other users by clicking on an appropriate link that identifies the “side conversation” and leads to the new comment thread. The side conversation can be represented by a thumbnail or an avatar image associated with each contributor in the side conversation. When a new comment thread is started, it prevents a stream of unrelated comments from being displayed with the original or main comment thread.

“Start a New Conversation”

This file allows a user to complete an interactive questionnaire in order to submit content and information for consideration by an administrator=and start a new conversation amongst other platform users. As part of the submission process, the user will be prompted to provide all or part of the elements of a conversation such as suggesting a headline, submitting lead in content such as a video or image, providing supporting content such as other articles Op-Eds, keywords, description or category for publication on the website. Once the information is submitted it is transferred to an admin page where the basic details submitted by the user can be seen and edited by a person with administrative access. At the option of the person with admin controls, the content can be published on the site as a conversation, and then be chosen as a featured conversation for the gallery or a home grid profile if promoting the conversation is desired.

“Profile Page”

This file allows a user to obtain information about their account and information contained therein. In order to access the profile page, a user must be logged into the platform under their public or private identity. This page may provide a status of any content submitted for publication on the “Start a New Conversation.” Additionally certain information can be viewed, updated, deleted or added by the user. For example, a user can view or track conversations they are active in on the platform by viewing what they have “liked,” commented on or added content to.

“Search”

The search function allows a user to enter a term to be search within the platform. Once the search is performed, the search results page will display all related conversations for the search term. For example, a search for “natural makeup” would reveal a page similar to that in Appendix A. Additionally, keywords within a conversation can be identified by the admin in order to provide search engine optimization. In one embodiment, the keywords can also include a hashtag in order to provide search results for related third party social network content such as TWITTER. The search function can also be used to search other platform users.

In addition to the foregoing, at the home page and/or some other suitable page, the system can present a link to files containing other useful information, or contain consistent headers that include “topics” toolbar, login/sign up, and search. The options are virtually limitless, but presently contemplated to files and or sites that are in the social media realm.

Navigating the System

With the foregoing descriptions in mind, reference will be made to FIGS. 2A-2C for further description of the system.

As illustrated in FIG. 2A, the client is presented with a home page 100 at the most basic URL address. In one embodiments, from the home page 100, the client can then hyperlink, directly or via the frames panel, to different pages including the “sign up,” page 102 “login,” page 104 “start a new conversation” page 106 “category page” 108 “search” page 109, “profile” page 110 or “settings” page 112, “topics” page 117, “conversation” 113, “about us” page 114, “team bios” page 116, “Privacy Policy” page 118, “Terms of Use” page 120, “Code of Conduct” page 122, “Contact Us” page 124 and “FAQ/Help” page 126. Some of these pages may also appear as frames on the home page 100. In another embodiment, the different pages are hosted on the platform URL address and internally linked. Additionally, the topic and category tabs serve as a directory for related conversation(s) or content within the topic or category. The names of the pages referenced herein can be revised to include a variation of the title. Additionally, other pages can be added to link from the homepage.

If the “Sign up” page 102 is selected, then from there the user will be prompted to fill out an interactive form and create a public and private user identity for the platform. As shown in FIG. 2B, which shows a flow chart of the sign-up process, a user can elect to create a public account via a third party social network which validates the user's public identity. The user can then proceed to finishing the sign up process. Alternatively, before completing the sign-up process, a user may be presented with other steps such as reviewing the websites terms and conditions and privacy policy. Once the sign up process is complete, the user can select an option to link their public account with a private login.

If as shown in FIG. 2B, the user elects to create a private identity, the user is prompted to submit a username, password and valid email address. Other information such as name, age, gender or the like may be requested during this step. After the username, password and valid email address are provided a validation step takes place. For example, an email may be sent from the admin or account control page to the user provided email address with a link to validate the user's identity. The user can then proceed to finishing the sign up process. Alternatively, before completing the sign-up process, a user may be presented with other steps such as reviewing the websites terms and conditions and privacy policy. Once the sign up process is complete, the user can select an option to link their private account with a public login.

If the “login” page 104 is selected, the user will be prompted to login to the platform under a public identity or a private identity. The link to the “login” page 104 can be placed on each file within the website in order to allow a user who is browsing the site to login at any time.

As shown in FIG. 2C, the login in feature for the public identity can include an option to login using third party social networking site credentials. Alternatively, before completing the log in process a user may be presented with other steps such as reviewing the website's updated terms and conditions and privacy policy. After the public login is complete, the user can interact with the platform with their public identity. Under a public login, the social name is displayed for your profile page when you interact with the platform, i.e. comment on a conversation, respond to a poll or start a conversation.

As shown in FIG. 2C, if a user elects to login into their private account, the login feature for the private identity will require the user to enter an account designator and corresponding password. Alternatively, before completing the log in process a user may be presented with other steps such as reviewing the website's updated terms and conditions and privacy policy. After the login process is complete the user can interact with the platform using a private alias. Under a private login, the private name is displayed for your profile page when you interact with the platform, i.e. comment on a conversation, respond to a poll or start a conversation.

If a user has elected to create both a public and private account, after logging in with either identity, the user can select to switch from a public identity to a private identify or vice versa.

The homepage of the website can include a gallery or lists of that serves as a directory of conversations. Each conversation can be presented in a frame, which if selected by the user will link the user to a page that contains the content leader, such as a video clip and a related headline for the content leader. Additionally, a ribbon of supporting or related content and a section to provide a comment or respond to a poll may appear under the content leader and associated headline. In some instances, if the user selects supporting content they may be directed to another webpage or an intermediary screen where they can provide a comment before leaving the platform. A user can also elect to share a conversation on a variety of social media platforms with a direct link back to the conversation.

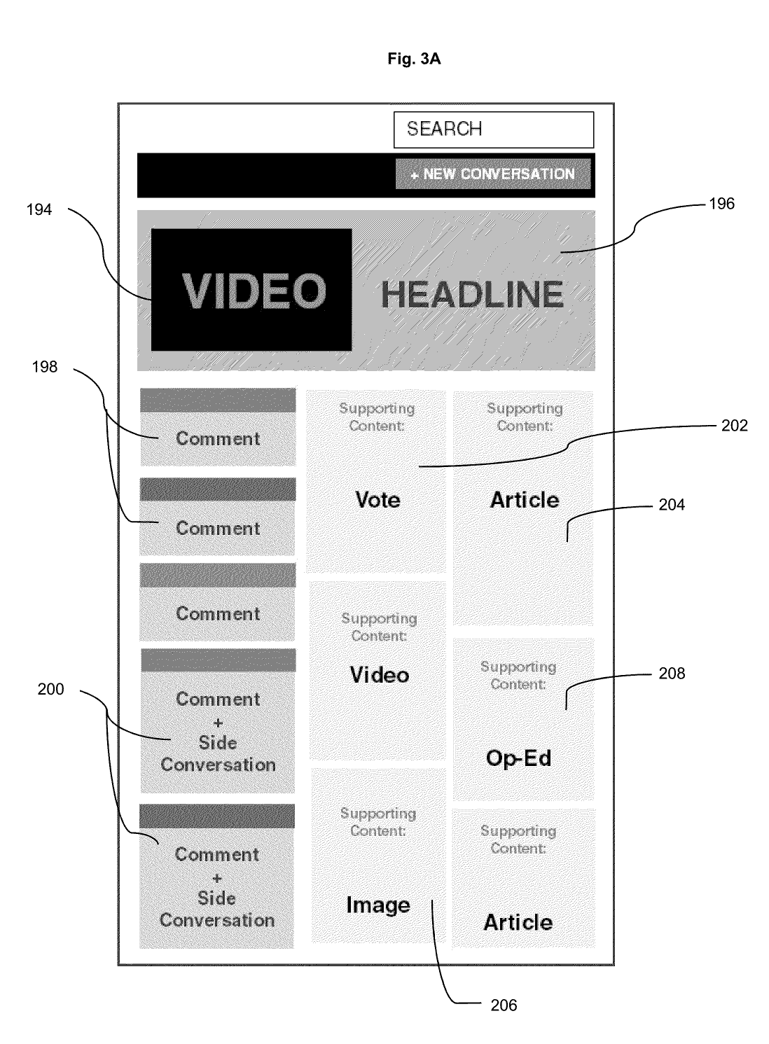

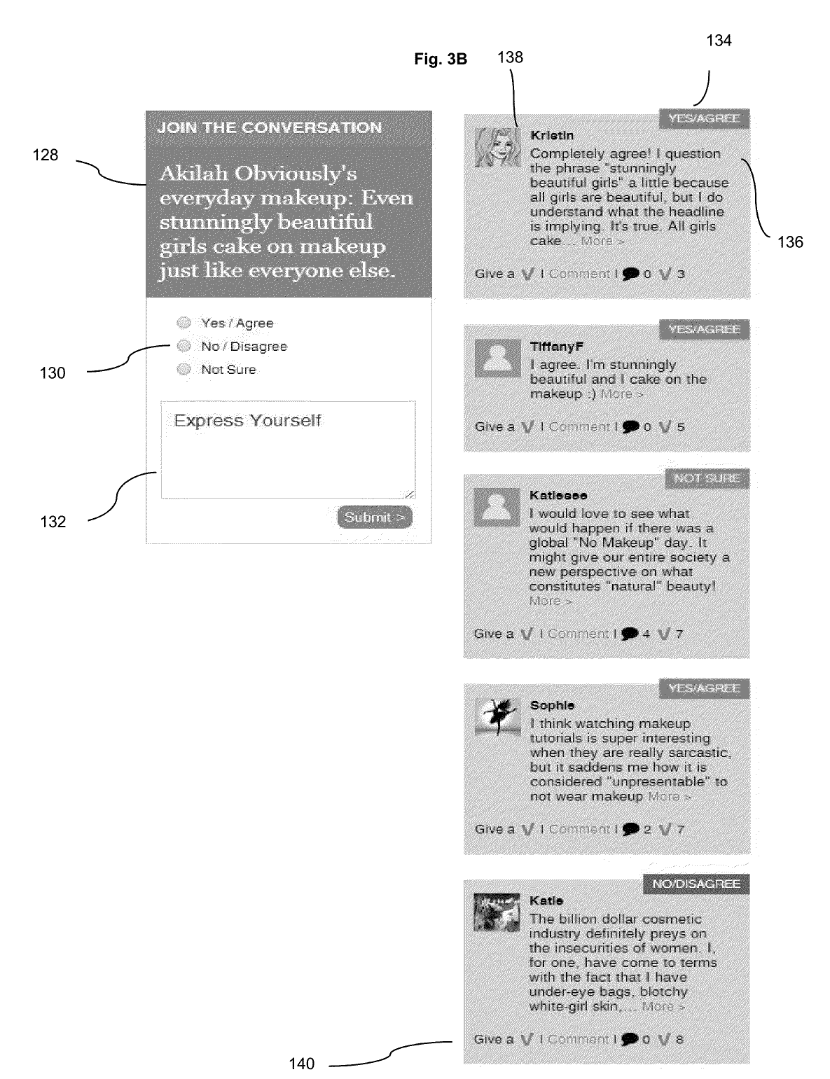

FIGS. 3A and 3B show in more detail the elements described above. Specifically, FIG. 3A shows a particular layout for the system described herein. In this embodiment of the platform, the lead in content 194, associated headline 196, related or supporting content 202, 204, 208 and 206, comments 198 and sub set comments 200 are accessible for users to read, interact, review and comment on. Any combination of the foregoing can make up a conversation and be referred to as a conversation. Specifically, in an embodiment, a conversation can include a lead in content, associated headline and comments. In another embodiment a conversation can include lead in content, associated headline, comments and supporting content. Yet further, in another embodiment, a conversation can include lead in content, associated headline, comments and supporting content and one or more comment sub sets. This layout and any combination of elements listed therein can serve as a template for other conversation on the platform.

The layout can include a headline 196 that can be posed as a question or statement invoking user response or opinion. An example of this user response is shown in FIG. 3B, which shows an option to provide a polling answer 130, comment 132 or both for the headline.

The layout can also include comments 198 and a link to a subset of comments 200 that are related to the lead in content and associated headline. The subset of comments can be referred to as a side conversation and consists of discussion and comments related to the lead in content and associated headline started by a users in which other users can respond. One benefit to the functionality of the subset of comments is that it allows users to discuss other topics, related issues or comments without interrupting the original comment stream for a particular conversation. Each subset of comments starts a new comment string, which can be accessed via a hyperlink to a new page, a pop-up window or other suitable means as would be understood by a person of ordinary skill in the art.

The layout can also include supporting content related to the content leader and associated headline. For example, additional video content 202, articles 204 or images 206 can be displayed for users to view. Each of these individual pieces of content can also include a comment ribbon and other function such as “like” or the like. The supporting content can serve to provide additional information or resources on the conversation topic to the user. Supporting content may be added to any conversation by any user, pending administrative approval.

Additionally, as seen in FIG. 3B, which shows an embodiment of a comment box 134 other features such an indicator for a particular user's position 136, a thumbnail or avatar associated with the user 138 and widgets 140 functions for a user to “like” another user's comment, report inappropriate comments or behavior on the platform can be included for navigating and interacting with the platform.

The type of lead in content and supporting content, i.e. video content or image or the like can vary within the layout or template described above. Additionally, the comments, and corresponding poll or questionnaire results will also vary based on user participation and interaction. Further, while a user may elect to start a side conversation, i.e. a subset of comments or discussion related to the initial or original conversation, there may be instances where the parent conversation or original conversation only include ribbon of comments.

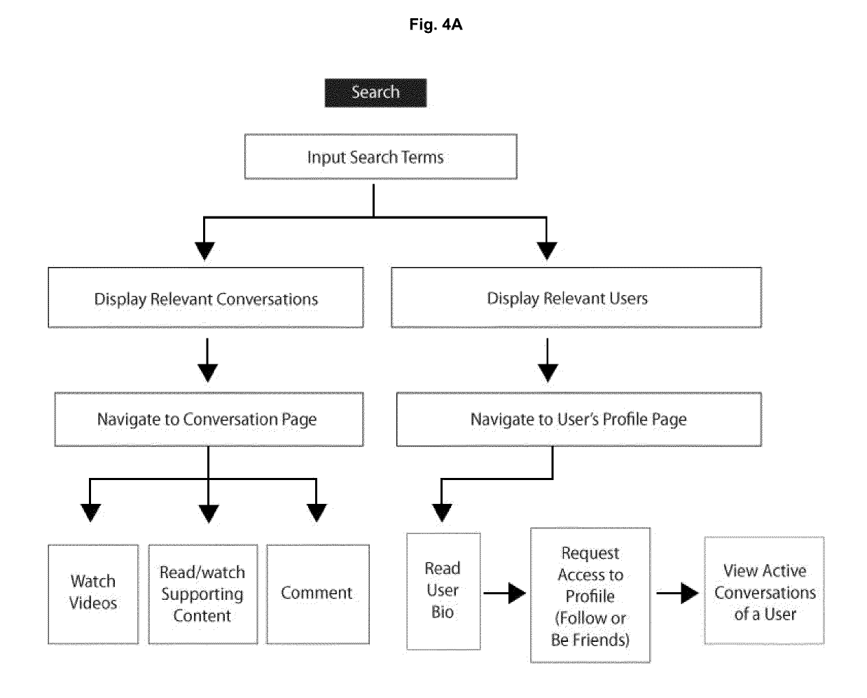

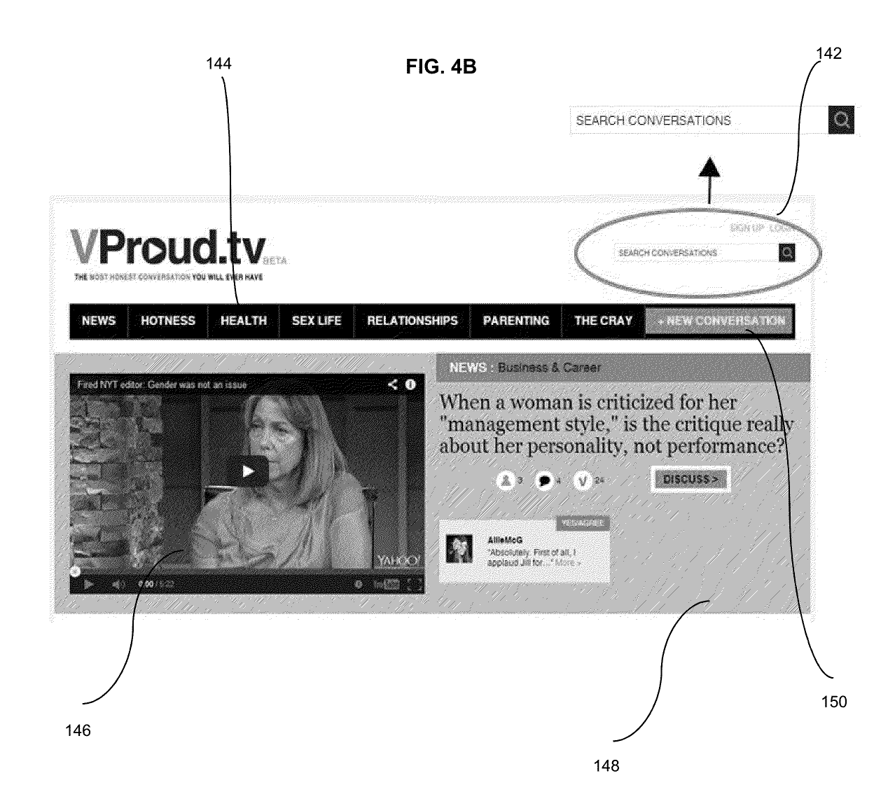

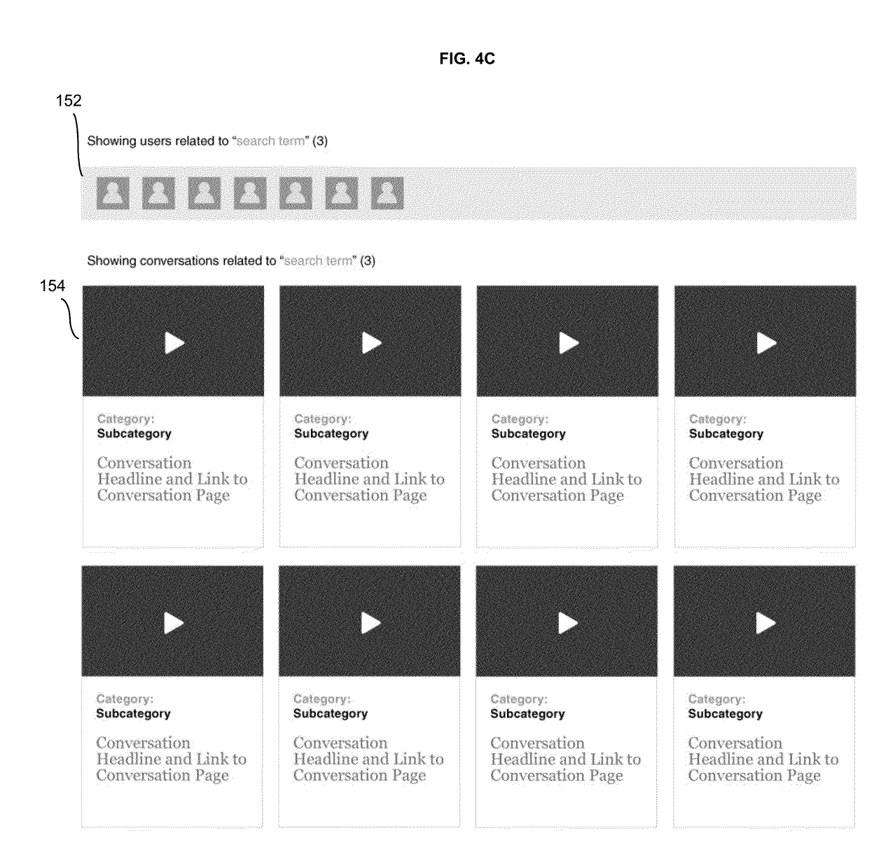

If a “search” 109 is selected or a term is entered to run a search on, then the user is directed to a search results page with all of the content related to the search topic on one page. For example, the search results page may include a list of video clip thumbnails and a related headlines for conversations that match the searched term. As shown in FIG. 4A, a user enters in a search term which can display relevant conversations, relevant users or both. If the user elects to review the relevant conversations they can navigate to a particular search result or conversation which with then allow them to watch a video, review and/or add supporting content, comment or any combination of the foregoing. If the user elects to review the relevant user search results, the user can navigate to a particular users profile page and read the user bio. A user bio page can include functions that enable the user to request access to the other user's profile page to follow the particular user or be included in a particular network, i.e. “Friend,” of the user. If a user is granted access request to another user's profile, they can view other active conversations of associated with the user.

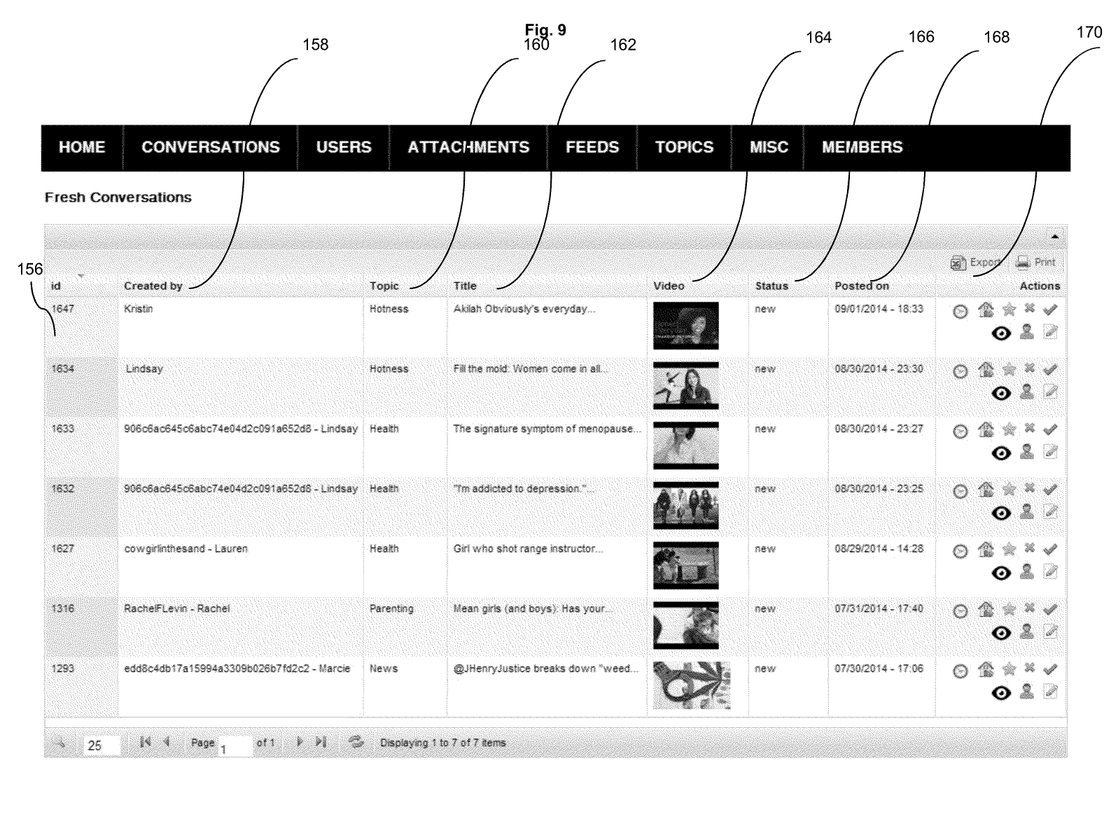

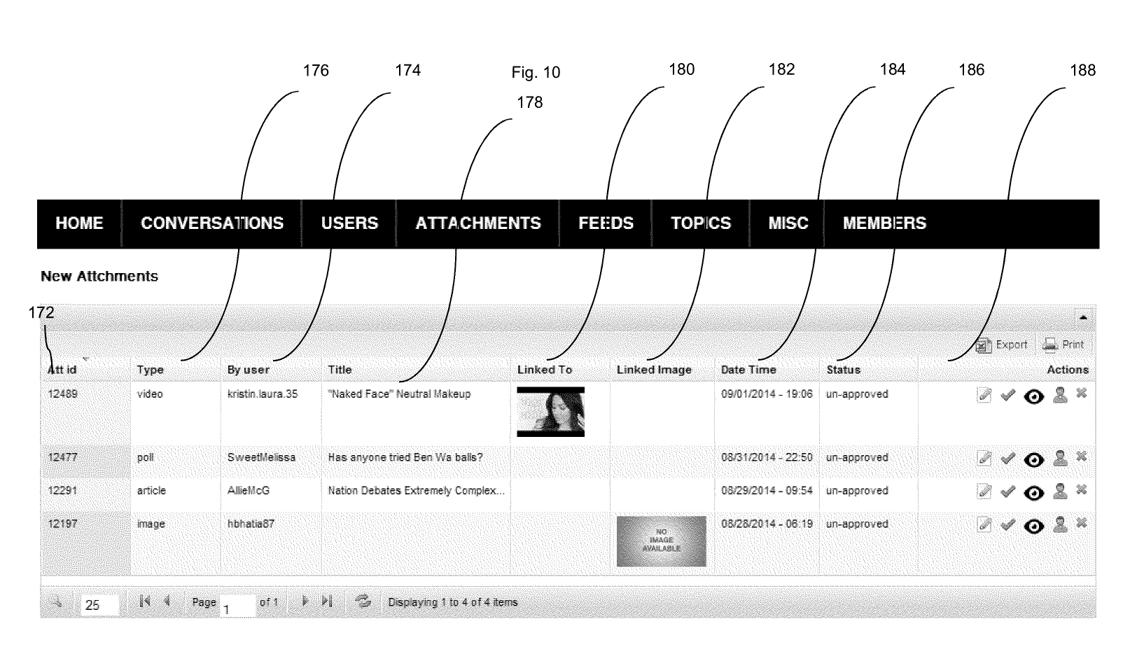

FIG. 4B presents a particular layout for a web page that shows a search bar 142 located in the header. Additionally, this layout also shows how categories or topics 144, a video content 146 and corresponding headline 148 for the content can appear in relation to the search bar 142. Additionally in this layout, the box identified as 150 shows the option for starting a new conversation, which if selected will prompt the user to a page with admin controls shown in FIGS. 9 and 10.

FIG. 4C shows a particular layout for search results entered into the search bar 142. The layout in this Figure shows search result for users related to the selected search term or terms where the user profile is depicted by a thumbnail or avatar image 152. The layout also includes the search results for conversations 154 related to the selected search term or terms. The layout of a search bar and the search results are not limited to those shown in FIG. 4C. A person of ordinary skill in the art would understand that the search results can be displayed in several different manners and layouts to accomplish different functions and design elements.

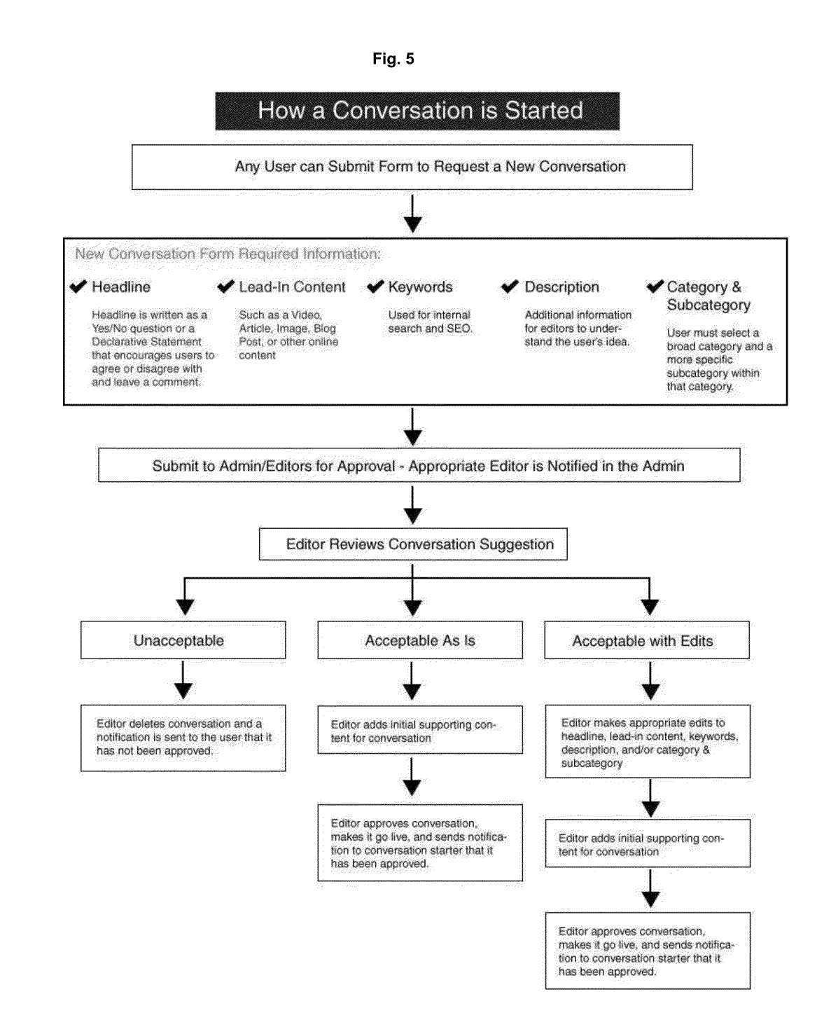

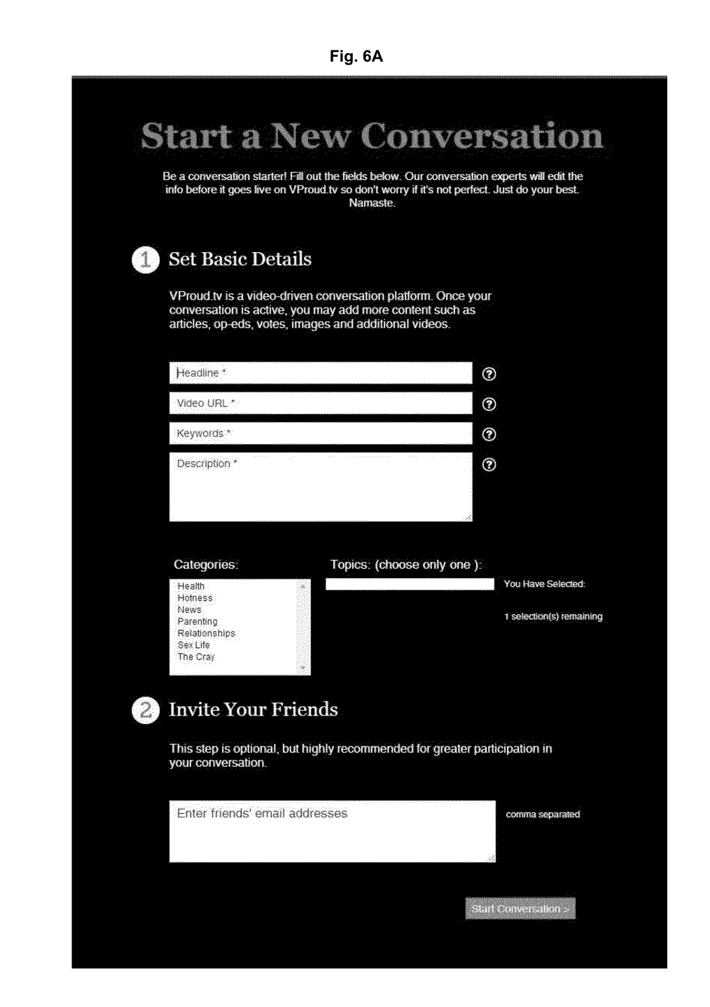

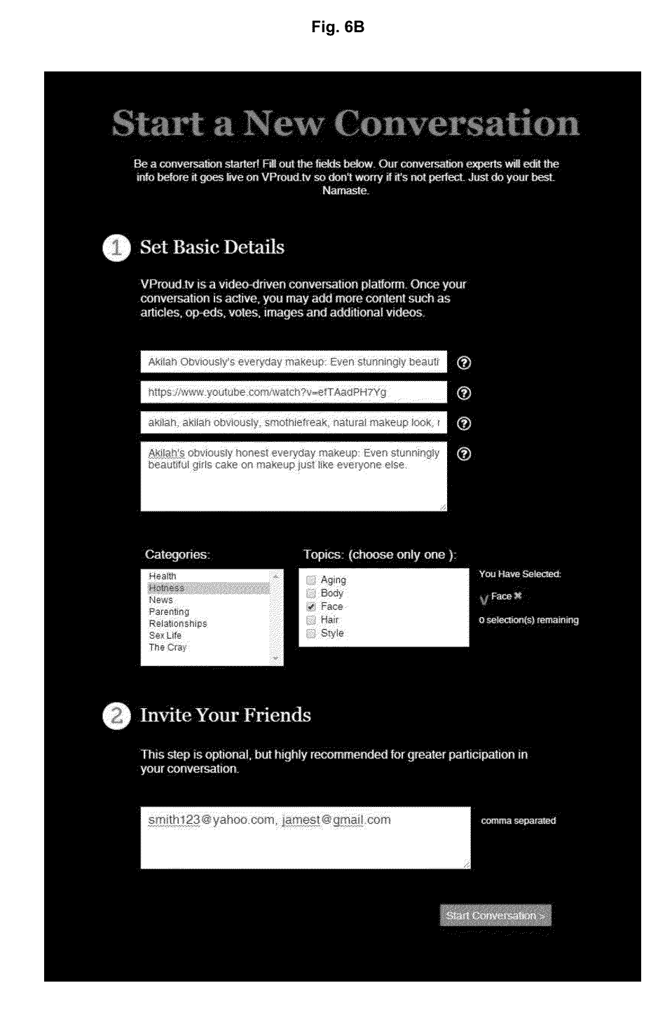

If the “start a new conversation” page 106 is selected, then the user is directed to a page that includes various interfaces structured to permit the user to provide information for a content submission and publication consideration. For example, as shown in FIG. 5, a user can select to submit a form to request a new conversation. The user is then presented with a form to fill out, which may require certain information to be entered. For example, the form can require the user to provide a Headline, provide lead in content such as a video, image, blog post, article or the like, key words that are associated with the submission, a brief description of the submission or a category or subcategory that the user's submission may fall under. An example of the form a user may be presented with is shown in FIG. 6A.

Once the Form is filled out, the user submits the form to the platform administrator. The platform administrator can be notified of a new submission as described in further detail below. When the platform administrator reviews the submission, they have certain rights to determine that the submission (1) is unacceptable and delete the submission, (2) is acceptable as is and add any additional supporting content before publishing the content, and/or (3) is acceptable with edits and make any appropriate edits to the submission, i.e. changing a headline, keywords, category or the like, and add any additional supporting content before publishing the content.

A user may also be prompted to visit the “new conversation” page if they run a search for a topic and receive search results that are not interesting to them, or not on point. In this case, the user can elect to start a new conversation as described above. Additionally, the user may have the option to submit an idea or topic of interest without providing additional content or information. In this instance, the admin can create the supporting content, headline and other necessary information for the idea or topic of interest and publish it on the platform.

FIG. 6B shows a representative example of how the form may be filled out. The fields that prompt a user to provide content or other information are not limited to the foregoing. A person of ordinary skill in the art would understand that the questions or fields can vary. Additionally, the fields presented to the user may prompt additional questions or fields depending on the information provided by the user. Under any circumstance or manner in which a user submits content for publication consideration, the submission will be directed to an administration page on the server side, which is described in more detail below.

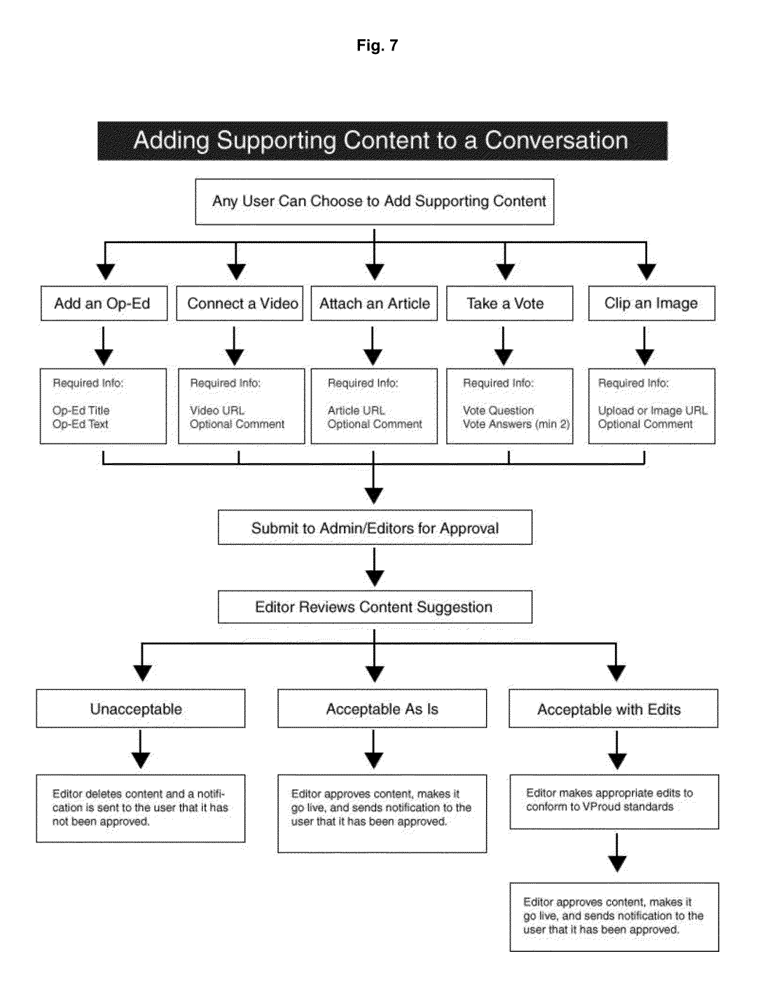

A user can also select to provide supporting content to any conversation. FIG. 7 depicts a flow chart for this process. For example if a user decides to submit supporting content, the user is presented with various options for the type of supporting content they would like to submit. For example, the user can select to submit an Op-Ed, video, article, a poll question or an image. After the user selects what type of content to submit, they must also provide certain required information for the supporting content. For example the an Op-Ed submission may require a title and the accompanying text for the Op-Ed piece, video may require a URL or other supporting file. Similarly, an article or image submission may require text, a supporting file or URL. If a user selects to submit a poll question, they may be prompted to enter the question and provide suitable answers for other users to select. Once the supporting content and required information are provided, the user can submit the supporting content for approval. The platform administrator can be notified of a new submission. When the platform administrator reviews the submission, they have certain rights to determine that the submission (1) is unacceptable and delete the submission, (2) is acceptable as is and add any additional supporting content before publishing the content, and/or (3) is acceptable with edits and make any appropriate edits to the submission, i.e. changing the link, thumbnail, wording or the like, and add any additional supporting content before publishing the content.

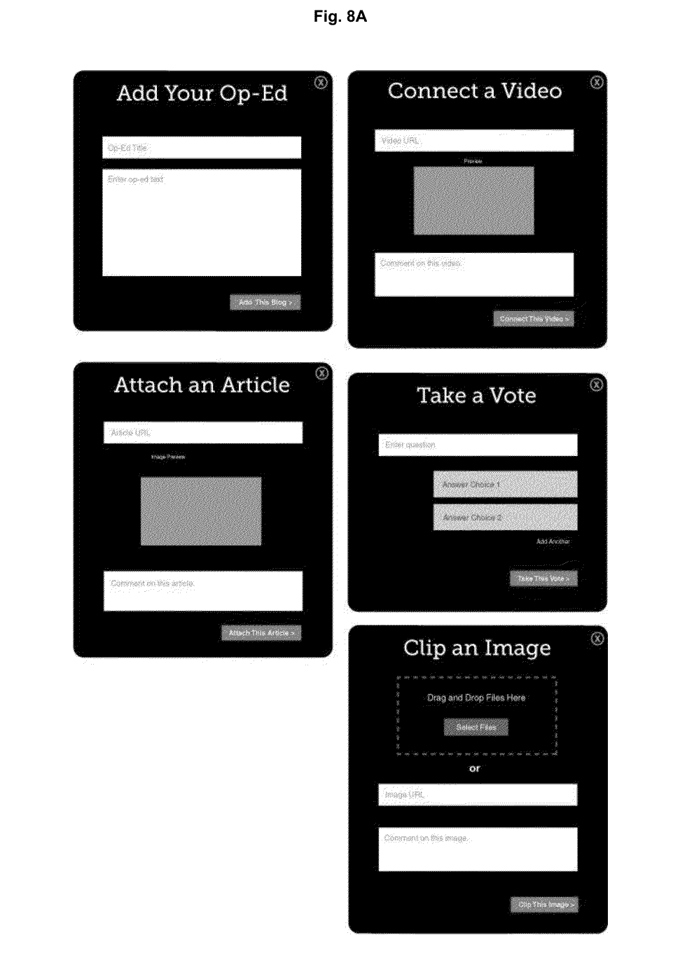

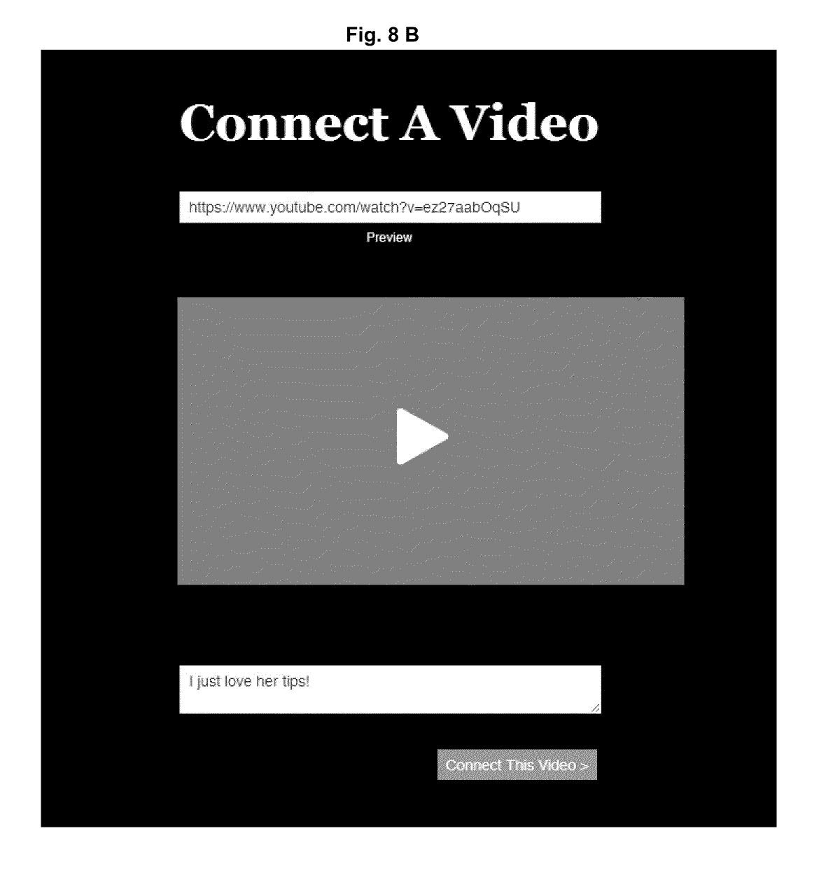

FIG. 8A shows a representative example of how a user can select what type supporting content to submit and FIG. 8B shows a representative example of how the supporting content submission for a video looks prior to submission. Under any circumstance or manner in which a user submits content for publication consideration, the submission will be directed to an administration page on the server side, which is described in more detail below.

If the “profile” 110 page is selected, then the user is directed through an account accessing procedure wherein the user is presented with interfaces and interrogatories structured to permit access only to those authorized to do so. Among those authorized would be the user themselves and platform administrators. Additionally, the user can selectively authorize other users or groups of users on the platform to see their profile, or certain aspects of their profile. Alternatively, the “profile” 110 page can be accessed if the user has already logged into the platform using their public or private identity, in which case the user can access their “profile” by selecting the link on the webpage that it appears. The “profile” 110 page contains information about the user and in some instances may provide an update on the status, including a hyperlink to the published content, or any user content submitted for publication consideration. Additionally, the user can view their active conversations, i.e. where they have provided a comment, “liked” another user's comment, and link to a particular conversation within the listing of their active conversations.

The “topics” 117 may appear at the top of the homepage in the form of a taskbar and allow the user to select certain topics of interest such as “News,” “Health,” “Relationships,” “Sex life,” and “Parenting.” This taskbar can also appear on other webpages accessed through the homepage to allow a user to select a new topic to browse from any part of the platform.

When a user selects a topic such as “News” the user will be directed to News category page which includes a list of conversations within this category. The conversations within each topic can be displayed as a scrolling gallery with a video link and a corresponding headline presented at the top of the webpage. Alternatively, multiple conversations can be presented as an infinite scroll with each conversation associated with a thumbnail.

In another embodiment a particular topic or category can include sub-categories. For example, a topic such as “News” may include subtopics such as “Business & Career,” “Crime,” “Justice & the Law,” “Education,” “Healthcare,” “Human Rights,” “Media & Entertainment,” and the like. These subcategories can be presented in a drop-down menu from the main navigation bar underneath the main topic. When a user selects a particular sub-category, they will be directed to various related conversations within each topic, which can be displayed as a scrolling gallery with a video link and a corresponding headline presented at the top of the webpage. Alternatively, multiple conversations with the sub-category can be presented as an infinite scroll with each conversation associated with a thumbnail.

When a user selects a particular conversation within the topic, they will be directed to a conversation which may have an a headline, a lead-in piece of content (such as a video), an interactive poll for a user to provide feedback or opinion on, and other related/supporting content. The user will also be able to see comments that have been posted, read side line comments or a subset of comments that can be referred to as a side conversation(s) and submit a comment or join a conversation if they choose on the conversation. Importantly, this interaction can occur with the users' public or private identity. Furthermore, the user may start out using their public identity and decide to switch to their private identity using the identity toggle feature.

Administration Page

FIG. 9 presents the administration database matrix useful in practicing the disclosure, which an administrator can call up after accessing the server 14. Administrator rights can be protected by requiring a unique identifier and password associated with the unique identifier for one or more administrators. In that regard, the server 14 in FIG. 1 includes a database with information concerning the content that user or users have submitted for publication consideration. In FIG. 9, the database includes detailed information for each conversation submission. For example each submission can be associated with a submission ID number 156, a user identity 158, and include the information such as the topic 160, the Title, 162 the content 164, the status 166, the submission date 168 and other Admin functions 170 such as “approve,” “delete,” “edit details,” “view user info,” “schedule autopost,” “set as a featured conversation,” or the like. The information associated with each submission and the admin functions are not limited to the foregoing and other options may be added as would be understood by a person of ordinary skill in the art. Further, the information provided in database matrix can have fields that are hyperlinked to other information files.

FIG. 10 shows an admin page for a supporting content submission. For example each submission can be associated with a submission ID number 172 a user identity 174, and include the information such as the type of supporting content 176, the Title 178, the content link 180, the status 186 the submission date 184 and other Admin functions 188 such as “approve,” “delete,” “edit details,” or “view user info” or the like. The information associated with each submission and the admin functions are not limited to the foregoing and other options may be added as would be understood by a person of ordinary skill in the art. Further, the information provided in database matrix can have fields that are hyperlinked to other information files.

The admin page can also include a mechanism to notify the administrator when user content is submitted. For example, a “new conversation” can appear in a “fresh conversation” or “new conversation” folder or be tagged with a similar identifier so the administrator can search for new submissions. Additionally an e-mail can be sent to an administrator with notice that a new submission has been made, a e-mail can also be sent with a summary of new submissions made within a set time frame, i.e. all submissions within an hour, 24 hours, a week, month or the like. A notification icon can also appear on the header of a page the administrator is on when the administrator is logged into the platform. New content can also be tagged with a topic or category identifier to allow an administrator to view all new content within a related topic or category. In some embodiments the content can be tagged according to a conversation category.

The administrator can administer the submissions and publish approved content such as a supporting article, video or image and administer and publish conversations from the various accounts set with the system. Additionally, the administrator can edit information prior to and/or after publishing the content or conversation, or elect not to publish the content or conversation at all. The administration page can also include a notification feature that allows the administrator to contact the user who has submitted content or a conversation for publication consideration to let them know the status of their submission and request and obtain any follow up information that may be needed by the administrator.

Additionally, the level of administration rights can be restricted based on a particular unique identifier allowing some administrators for example to access or edit content and notify users, while another administrator may have access to publish the content after it is approved.

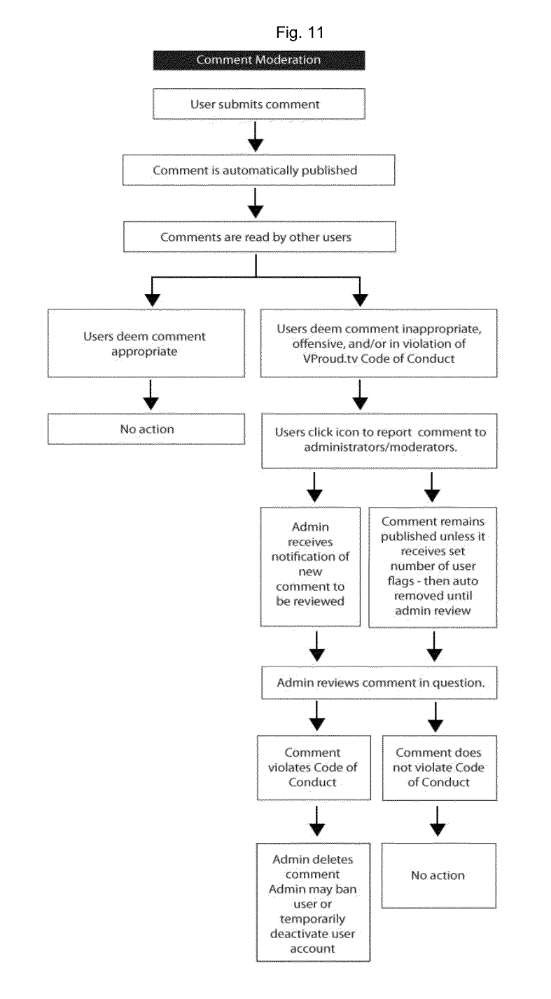

The platform also includes a system to moderate comments and prevent “trolls” from leaving hateful or inappropriate comments on the platform. Inappropriate comments may be flagged by other users, for review by an admin. FIG. 11 illustrates an example of a process in which comments or other content can be flagged by a user and reviewed by an administrator. When a user submits a comment it is automatically published on the platform and read by other users. If no user flags the comment as inappropriate, the comment remains on the platform and no further action is taken. If a comment is flagged for being inappropriate or in violation of the platform's terms, a user can click on an icon to report a particular comment as inappropriate. In some embodiments the icon can be referred to as a “troll icon” and comment policing is referred to as “reporting a troll.” After one user has flagged a comment, it is sent to the comment review area of the admin page. The comment can remain live until further action or no action by the administrator or the comment can be automatically removed if a predetermined number of flags are associated with a particular comment. For example, an administrator can require that any comment with 5 or more flags is automatically removed from the platform while a comment with less than 5 flags remains active on the platform until further review and action by the administrator. Additionally, some user accounts may be immune to having their comments flagged based on the user's particular history. In these instances, an administrator can tag or identify a user in some other manner so their comments override any preselected number of flags resulting in automatic renewal and remain posted regardless of the flags associated with a particular comment. In the comment review process, the administrator can review flagged comments or content and determine if the content is in violation of platform rules or otherwise inappropriate and delete the comment, ban the user, temporarily deactivate a user account or any combination of the foregoing. If the administrator determines the content is appropriate they do not need to take any further action to allow the comment to remain on the platform, they may also mark the comment as immune to future flagging so as to eliminate future administrative review on the same comment. If a comment was automatically removed from the platform, the administrator can review the comment and decided to republish the comment if it is deemed appropriate or ban the user, temporarily deactivate a user account or any combination of the foregoing.

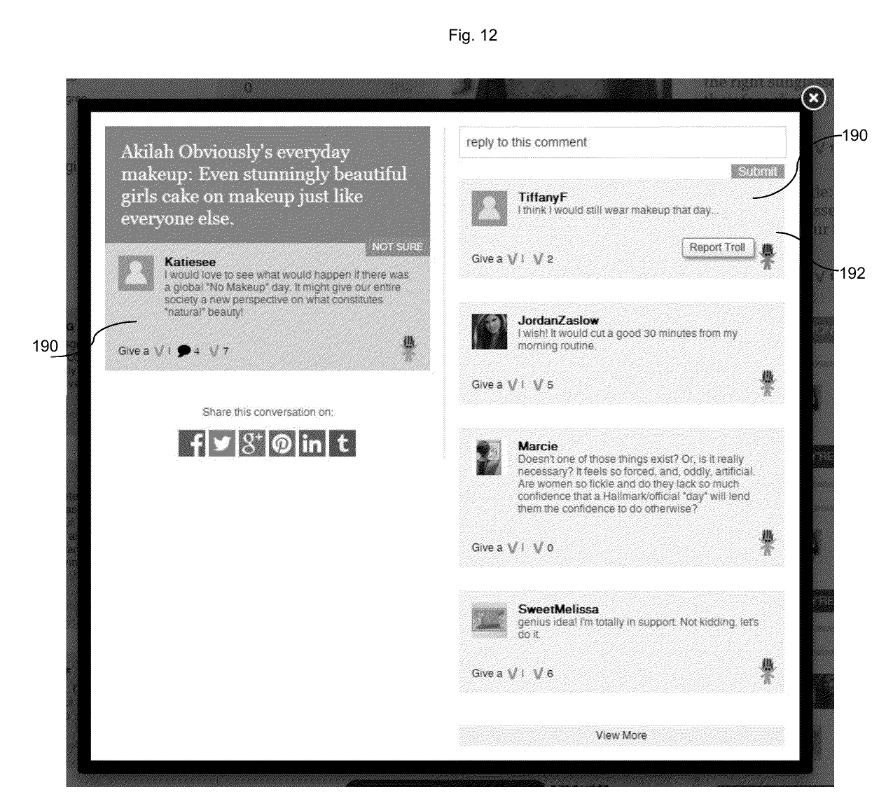

FIG. 12 shows a particular layout for the comment monitoring discussed above. The layout in this FIG. 12 shows comments made by individual users 190. Within each comment box is an icon 192. Other platform users can click on the icon 192 to flag the comment as inappropriate to the platform administrators. A person of ordinary skill in the art would understand that the method of flagging comments is not limited to an icon, be displayed in several different manners and layouts to accomplish different functions and design elements.

From the foregoing description, it can be seen how an internet platform provider can provide a platform via a network such as the Internet that allows users to participate under a public profile or a private alias, easily search the platform for topics of interest and navigate comments posted by others. Additionally, the platform provider has the capability to consider publishing user generated content submitted via the platform to address a new topic or generate new conversations among its users. The user can submit content to the administrator, which the administrator can process and review prior to deciding if the content will be published. Additionally, the administrator can have further communications with the users prior to publication to discuss edits to the content.

Although modifications and changes may be suggested by those skilled in the art, it is the intention of the inventors to embody within the patent warranted hereon all changes and modifications as reasonably and properly come within the scope of their contributions to the art.

What is claimed is:

1. A network based system comprising:
an interface accessible from said network via which a human client submits content for publication on a platform;
a database comprising information related to the content;
an administrative interface associated with the database comprising a matrix for the content,
wherein,
the administrative interface is configured to publish the content from the human client on the network based system.

2. The system according to claim 1 comprising an administrative matrix interface comprising a matrix including a subset of data from the database, including submission status information for the content.

3. The network based system according to claim 1 wherein the administrative interface is configured to edit the content before publication on the platform.

4. The network based system according to claim 1 wherein the content is not published on the platform until the administrator approves the content for publication.

5. A network based system comprising:
an interactive platform comprising a lead in content and an associated headline.

6. The network based system according to claim 5 wherein the human client creates an account to access the network based system.

7. The network based system according to claim 6 wherein the human client uses an existing social network public identity accessed through an API to create a public account.

8. The network based system according to claim 6 wherein the human client creates an account designator and corresponding password to create a private account.

9. The network based system according to claim 6 wherein the human client uses (a) an existing social network public identity accessed through an API to create a public account and (b) creates an account designator and corresponding password to create a private account.

10. The network based system according to claim 9 wherein the public account and private account are associated with each other.

11. The network based system according to claim 10 wherein the human client can switch between a public account and private account on the network based system.

12. The network based system according to claim 5 wherein an interactive questionnaire is associated with headline and the human client is prompted to provide a response to the questionnaire, a comment or both.

13. The network based system according to claim 12 wherein a plurality of human client responses to the questionnaire are displayed on the platform.

14. The network based system according to claim 13 wherein the plurality of human client responses are coded according each human client response.

15. The network based system according to claim 14 wherein the plurality of human client responses are color coded.

16. The network based system according to claim 13 wherein the results of the interactive questionnaire are compiled in an illustrative chart.

17. The network based system according to claim 16 wherein the illustrative chart is a pie chart, bar graph, scatter plot chart, distribution chart, venn diagram or line graph.

18. The network based system according to claim 12 wherein a user can initiate a new string of comments by posting a side comment.

19. A network based system comprising:
an interface accessible from said network via which a human client submits a comment on a platform;
a means on the platform for flagging the comment by other users; and
an administrative interface associated with the platform comprising a matrix of flagged content,
wherein,
each comment is associated with a human client, and
the administrative interface is configured to review the comment.

20. The network based system according to claim 19 wherein the administrative interface is configured to automatically delete any comment with a predetermined number of flags.

21. The network based system according to claim 20 wherein the administrative interface is configured to override the automatic deletion of a comment for a human client selected by the administrative interface.

22. The network based system according to claim 19 wherein another human client can flag a comment.

23. The network based system according to claim 1 wherein the network is on the world wide web.

24. The network based system of claim 6 wherein the network is the internet.

25. The network based system according to claim 18 wherein the network is the internet.
